(19) United States
(12) Patent Application Publication
(10) Pub. No.: US 2014/0345176 A1
(43) Pub. Date: Nov. 27, 2014

(54) REALTY SIGNS AND YARD POSTS

(71) Applicants: Frank L. Okert, Liberty Boro, PA (US); Keith R. Mccaulley, White Oak, PA (US)

(72) Inventors: Frank L. Okert, Liberty Boro, PA (US); Keith R. Mccaulley, White Oak, PA (US)

(21) Appl. No.: 14/284,353

(22) Filed: May 21, 2014

Related U.S. Application Data
(60) Provisional application No. 61/825,967, filed on May 21, 2013.

(51) Int. Cl. G09F 7/22; G09F 15/00; G09F 7/18

(52) U.S. Cl. CPC G09F 7/22; G09F 7/18; G09F 15/0068; G09F 2007/1813; G09F 2007/1873; G09F 2007/1856
USPC 40/606.03; 40/607.01; 40/607.12; 248/530; 256/19; 83/23

(57) ABSTRACT

A modular realty signpost comprising a first vertical sign section made from extruded vinyl tubing; a second horizontal sign section made from extruded vinyl tubing and designed to intersect and connect with the first vertical sign section; and a plurality of clip and bracket combinations for holding a swinging realty sign, each of said clips designed to fit in an aperture in a bottom surface of the second horizontal sign section. A method for making same is also disclosed.

### CROSS-REFERENCE TO RELATED APPLICATION

This application is a perfection of Provisional Application Ser. No. 61/825,967, filed May 21, 2013, the disclosure of which is incorporated herein.

### BACKGROUND OF THE INVENTION

1. Technical Field

The present invention generally relates to sign posts and more particular to a post for hanging a realty (or “for sale”) sign. This invention further relates to other yard posts including mailbox supports and fence posts.

2. Relevant Art

In real estate and other fields, it is useful to have a conspicuous sign in the yard for informing the public that that property or product stored at that location is available for purchase. Today, the most popular yard signs are manufactured from 4×4 inch sections of lumber joined to form a vertical post and horizontal top arm. A realty/realtor's sign hangs from the bottom of that horizontal arm. Additional banners may be placed on top or from the bottom of that horizontal arm or the sign hanging therefrom.

Typically, signs with the real estate company's name and listing agent swing from two S-hooks positioned on a ring or hook secured to the bottom of that horizontal arm. “Open House”, “Sale Pending” or other information may be placed atop the arm. In some instances, a flyer box may be nailed or otherwise secured to one side of the vertical post. It would hold printed information sheets regarding the property for passersby to take for learning more particulars about the property being sold.

Current 4×4 lumber posts are rather heavy and bulky to transport, especially when pre-connected (or otherwise joined into one assembly). They can prove challenging to install and remove (eventually). Professional installers are usually contracted to perform such on site installations and removals. Holes for the vertical posts must be dug or drilled using a lot of manpower/muscle and raising the risk of accidentally striking an underground pipe, power/cable line or tree root.

More recently, alternate post signs have been manufactured from lighter gauge metal tubing and plastic (e.g., PVC), often in the cross-sectional shape of a square. Such signposts have been installed by digging and setting the vertical post in place, or by driving stakes through a holding bracket/tube onto which is mounted the vertical post component.

For many realty, mailbox and/or fence post installations, a pick ax, shovel, double handled post hole digger or other tool is needed to create a deep enough hole into which the main vertical component will be placed. Alternately, a sledgehammer or other heavy striking tool may be used for driving the mounting element of newer post designs into the ground.

Still other replacements for the aforementioned 4×4 wooden post signs, some modular, have been disclosed and patented. In chronological order, these include: Classen U.S. Pat. No. 4,279,104; Barth U.S. Pat. No. 4,326,352; Amick et al. U.S. Pat. No. 4,357,772; Still Jr., U.S. Pat. No. 4,524,533; Gannaway U.S. Pat. No. 5,722,205; Allen U.S. Pat. No. 7,089,694; Brumfield U.S. Pat. No. 7,389,603 and Hill U.S. Pat. No. 8,082,702. Still other relevant disclosures include Published U.S. Patent Application Nos. 20060042138 (to Lavelle) and 20110036026 (to Lee).

For sign hanging clip considerations, see: Patterson Jr., U.S. Pat. No. 4,089,129; Fournier U.S. Pat. No. 5,274,936; Kim U.S. Pat. No. 6,971,199; Orsos U.S. Design Pat. No. D342,286 and Tigchelaar U.S. Design Pat. No. D515,143.

An object of this invention is to provide a less bulky realty (or other) signpost that can quickly and easily install over a device- or machine-driven anchor, pin or dart. Another object is to provide lightweight vinyl post constructions requiring fewer parts (such as end caps or the like). Yet another object is to provide sign attachment means to vinyl horizontal arms that enable free, yet safe swinging back and forth with the wind. Still another object is to enable such sign clippings to be retrofitted to existing wooden posts.

### SUMMARY OF THE INVENTION

One preferred embodiment of the present invention comprises: a mounting dart that can be driven in the ground to a sufficient depth safely above the depths at which most utilities (i.e., water, sewage, power and/or cable lines) are buried underground; a first vertically-oriented sign section which gets mounted onto that dart; a second horizontally-oriented sign section that intersects with and at least partially extends into the first sign section, preferably at a right angle to same; and a plurality of (i.e., at least three) clip and bracket combinations from which a hanging sign may be mounted.

Preferably, the first and second sign sections are made from lightweight vinyl (or PVC) tubing, square in cross-section. The outermost ends to both first and second sign sections may be bevel cut, heated and merely folded to form a tip rather than requiring a square-shaped end cap component that would otherwise be lost or stolen. Other cuts, heating and bending can produce the alternate ends/tips shown in accompanying FIGS. 17A and B.

Optionally, a flyer box mount (not shown) may be added to one, or both, sign sections. The device may include still other features such as recording means and/or a radio transmitter for broadcasting house information to immediate passersby.

### BRIEF DESCRIPTION OF DRAWINGS

Further features, objects and advantages of this invention will be made clearer from the following detailed description made with reference to the accompanying drawings in which:

FIG. 1 shows a front perspective view of one embodiment of signpost on a silhouetted mounting stake per one embodiment of this invention;

FIG. 2 shows segmentally, in perspective view, the various elements to the signpost, stake, clips and realty sign from FIG. 1;

FIG. 3 is a top perspective view of one embodiment of mounting stake for use with the present invention;

FIG. 4 is a front perspective view of one embodiment of clip and sign bracket;

FIG. 5 is a partial perspective, exploded view showing the clip from FIG. 4 as modified with additional straps for use on an existing wooden realty signpost;

FIG. 6 is an underside perspective view of the fully assembled clip unit from FIG. 5;

FIG. 7 is a segmentally separated, perspective view of the various components of realty sign before assembling together;

FIG. 8 is a perspective view, in partial cutaway, showing a beveled edge to one vinyl post having its forward most end cut per one embodiment of this invention;

FIG. 9 is a perspective view, in partial cutaway, showing the cut edges from FIG. 8 on a platen for heating before joinder;

FIG. 10 shows two perspective views, in partial cutaway, with the post taken off the platen in the lower view and then folded toward one another for joining along immediately adjacent edges in the upper view;

FIG. 11 is a longitudinal perspective view showing the underside to the one preferred embodiment of vertical vinyl arm from which clips and a realty sign would be installed;

FIG. 12 is a perspective view, in cutaway, showing the fin end to one mounting stake according to the present invention;

FIG. 13 is a top perspective view of one assembled clip and sign bracket configuration according to one embodiment;

FIG. 14 is a close up perspective view of the clip and bracket from FIG. 13 with a realty sign attachment bolt extended there through, said clip being installed into the vinyl arm of FIG. 11;

FIG. 15 is a perspective view photo showing three clips/brackets in a vinyl arm for holding a realty sign according to the present invention;

FIG. 16 is a top perspective view of a 3-post commercial realty sign per a first alternative embodiment;

FIG. 17A shows, in adjacent perspective views, a first alternate sign tip with a single beveled flap to an inclined arm end; and

FIG. 17B shows, in adjacent perspective views, a second alternate sign tip with a single beveled flap to a squared arm end.

### DESCRIPTION OF PREFERRED EMBODIMENTS

Referring now to the drawings, there is shown several embodiments of the invention. In the accompanying drawings, common elements are commonly numbered in the respective views. For the alternative embodiment, common elements are consistently numbered though in the next hundred series.

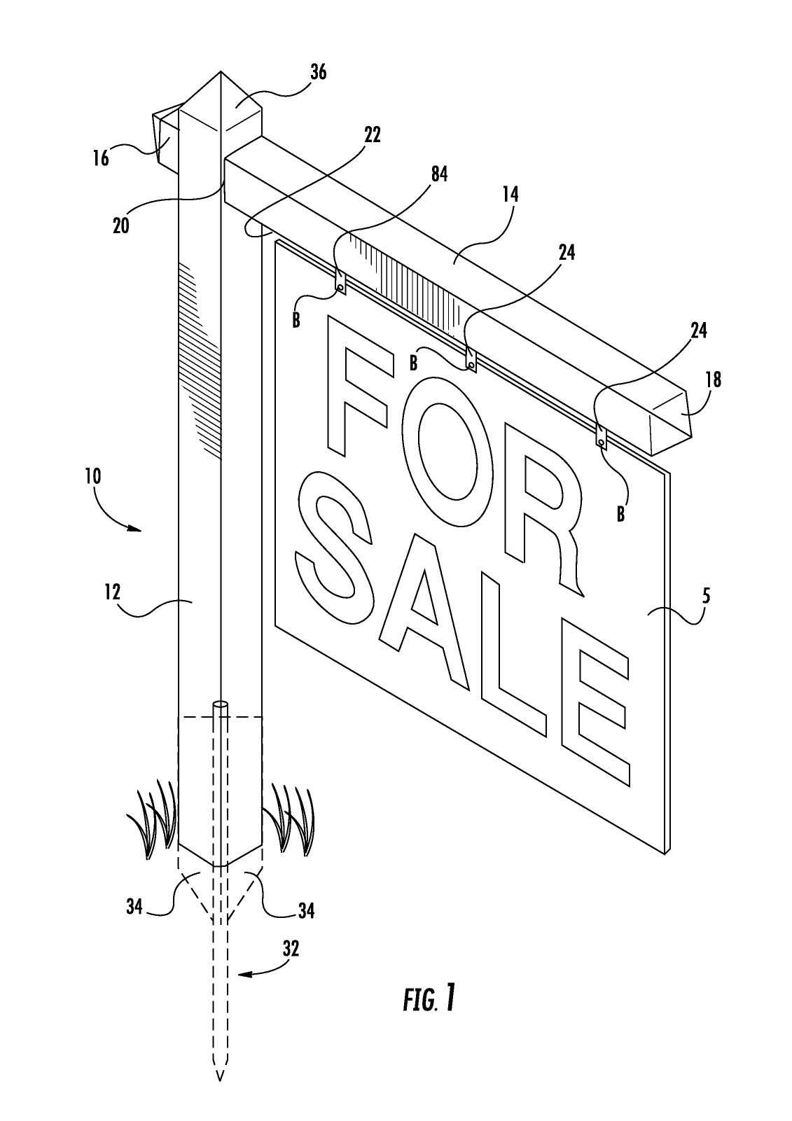

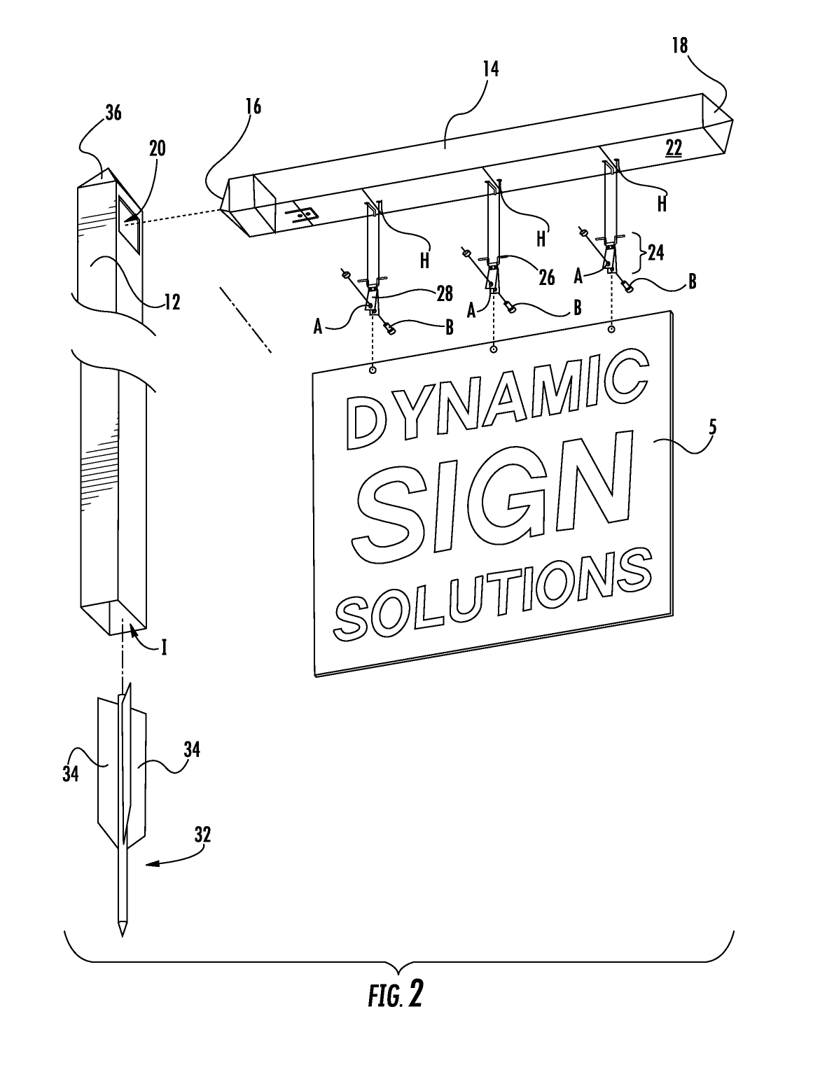

With reference to FIGS. 1 through 4, there is shown a realty sign 5 extending from modular signpost, generally 10, according to one preferred embodiment. Any and all relative dimensions of component parts are merely representative. This invention may also be sized and/or shaped differently. For instance, when using a vertical post as a mailbox support or one of many vinyl fence posts, it will surely be shorter than the realty posts depicted in the drawings. And when used as other than permanent realty signs (i.e., for temporary “for sale” purposes), vinyl or PVC posts weigh substantially less than their wooden counterparts. Depending on which wood materials are used and/or whether such woods are pressure treated, signpost 10 may weigh as little as 10 to 25% of its current wooden “equivalent”.

In one embodiment, the first (vertical) sign section 12 of signpost 10 would generally measure about 68 to 80 inches in total length with 72″ long standard posts being preferred. It is understood, however, that for some applications (such as for visibility above/over hedges and/or higher yard fencing, still longer vertical post constructions would also be made by this invention. For most realty sign applications, the horizontal component 14 should extend about 40 to 50 inches with a 48″ long standard post arm being preferred. After cutting that bevel and forming its outer tips 16, 18, that horizontal arm measures about 46¾ inches overall.

Unlike prior art posts that have to be partially buried; all of the foregoing is useable above ground. Fitting at least partially into an aperture 20 cut or preformed into first vertical section 12 is that second (horizontal) section 14. On a preferred basis, vertical post 12 measures about 4 inches across, from outer wall to the opposing outer wall. The horizontal post 14 measures about 3.5 inches across. When at least the vertical post has a hollow interior (if not both vertical and horizontal sections), the invention anticipates horizontal section 14 storing mostly inside vertical section 12 when not assembled for realty advertising purposes.

Preferably, second sign section 14 extends perpendicular to first section 12, i.e. at a 90° angle relative to each other. In some instances, however, it may be aesthetically distinctive to make the two main sections extend at other than a right angle to one another. Mounted on either the first section, second section of both sections is an optional flyer box (not shown).

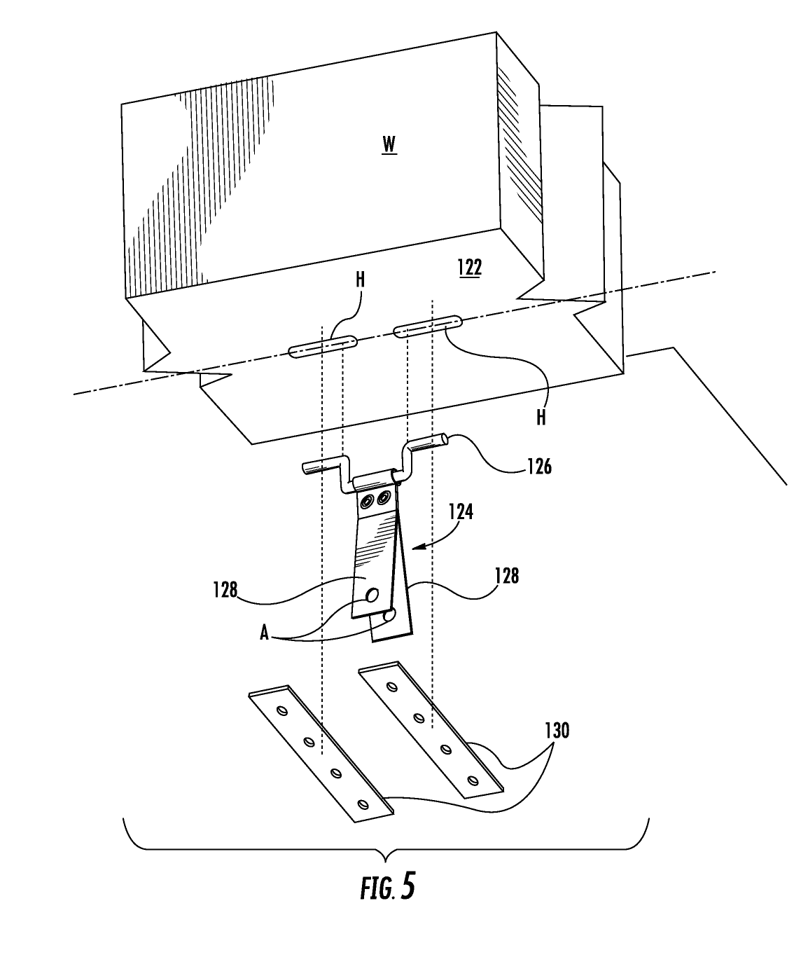

A realtor (realty company) sign 5 hangs from the underside 22 to the second (horizontal) sign section with a plurality of clip/bracket combinations, generally 24. As seen in FIG. 4, a top end 26 to each clip has multiple “bends” for easily fitting into pre-drilled clip holes H in the underside 22 to second section 14. Ideally, these clip/brackets 24 and clip holes H are commonly spaced apart, preferably about 10 to 12 inches from one another (and not necessarily from the center of the cross arm per se), more preferably 11 inches apart, for a more universal application of this invention and use by multiple realty companies in multiple regions of the country.

It has been determined that a set of two clip/brackets 24 towards opposite ends of the realty sign will not suffice to protect sign 5 from unduly bending in a strong wind.

Optimally, a sign fastened with at least three (preferably commonly spaced) clip brackets 24 will provide better attachment AND better protection against potential wind damage. In an alternate embodiment (not shown), there are four clip/bracket combinations per yard sign/signpost.

There are two ways to install a typical realty sign 5 onto signpost 10: (1) all three bracket ends 28 are first joined with bolts B (or otherwise attached) through apertures A in the top of sign 5 before all three clip/brackets 24 are wiggled into their corresponding holes H in the underside 22 to horizontal (second) sign section 14. Alternately, (2) all three clip/brackets 24 (alone) are first inserted into their respective holes H in horizontal sign section 14 after which main sign 5 gets connected, via bolts B, to the pre-installed clips. Because typical realty signs are made from rigid sheet metal (most often, aluminum), it may not be possible to install an inflexible sign into a horizontal bar one clip/bracket at a time.

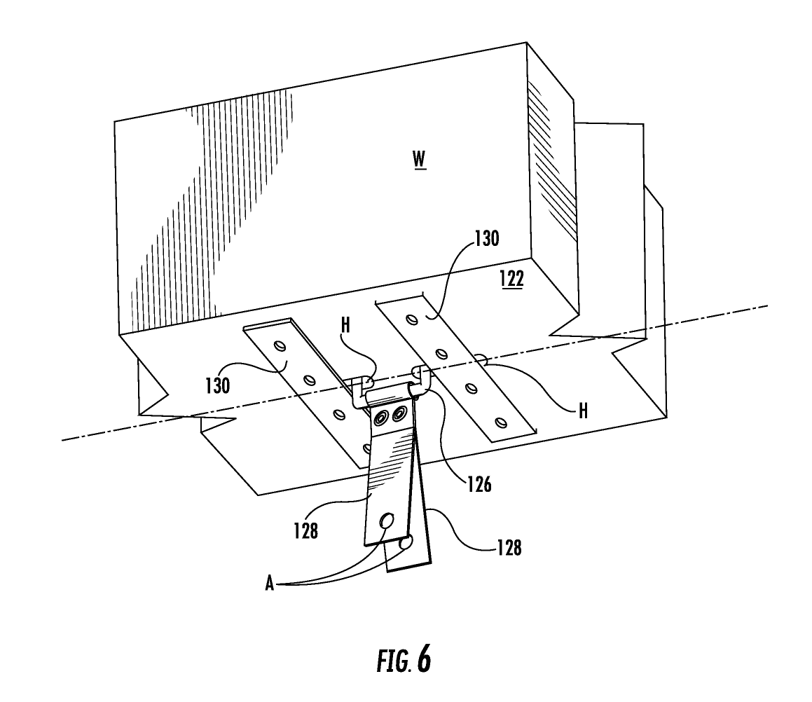

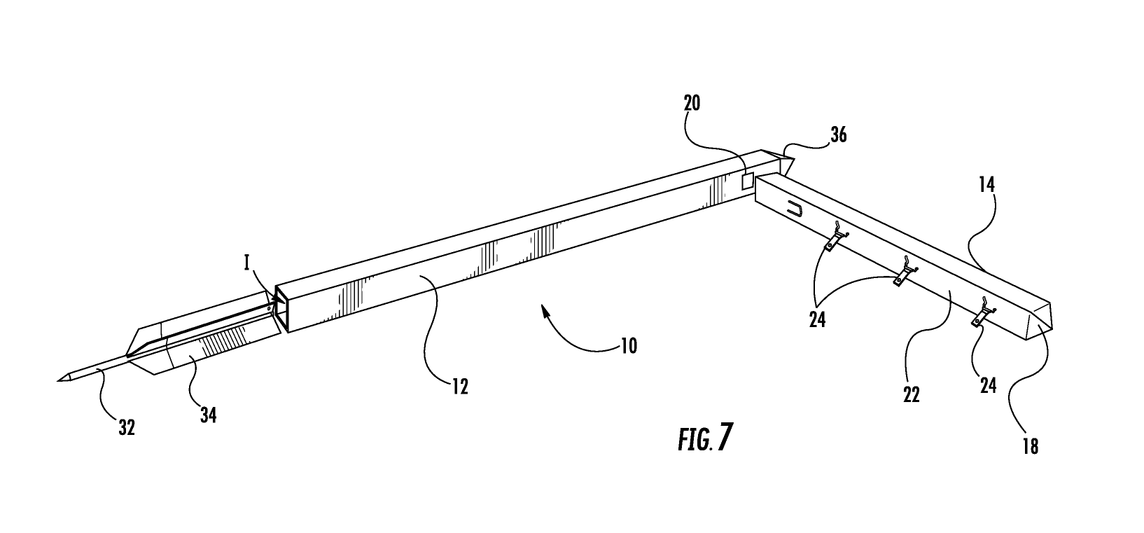

The aforementioned clip/bracket combination should also work, with modification, for hanging signs from an existing wooden crossbeam. FIGS. 5 and 6 show one such modification scheme. Particularly clip/brackets 124 therein would be inserted into holes H cut or drilled into the underside of a wooden crossbeam W after which cover brackets 130 would be installed with bolts or screws (not shown).

One can always hang additional/supplemental signs, via S-hooks, for example, beneath main realty sign 5 according to this invention. These S-hooks may be crimped to permanently attach an agent's name, website and/or phone info below the main signage, such crimping intended to prevent the secondary sign from blowing off in the wind. Into the top surface of second (horizontal) section 14, one may also position another informational banner (not shown).

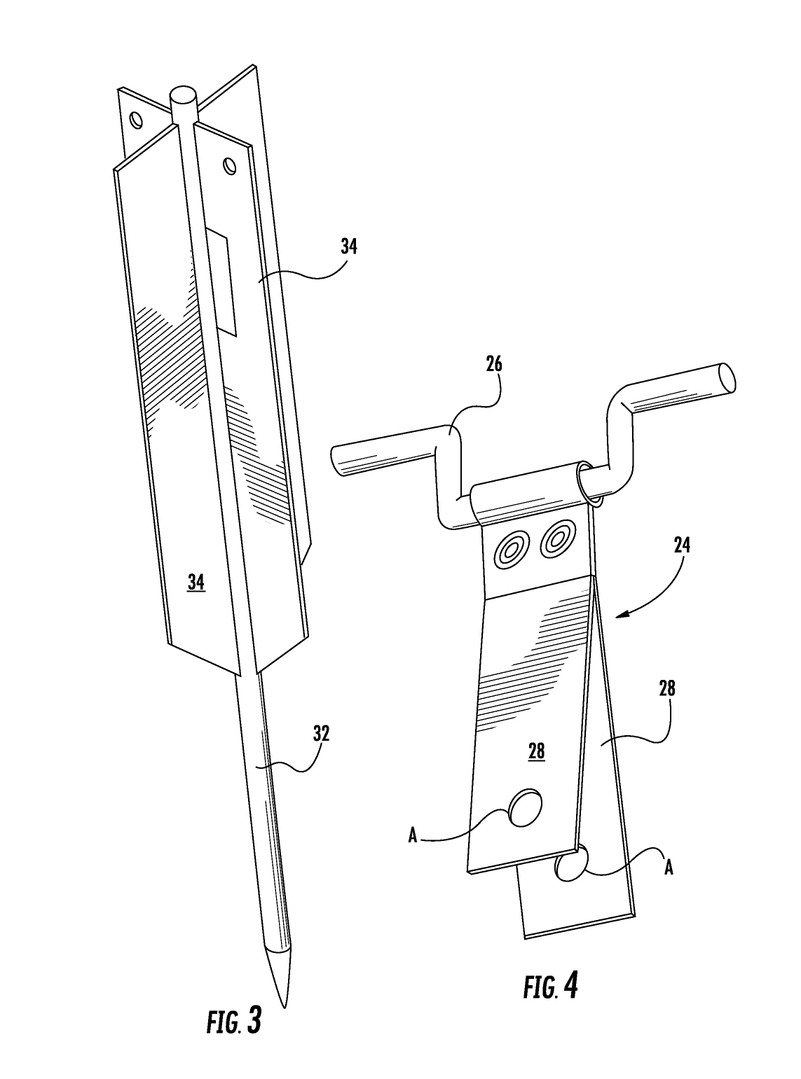

One preferred means for mounting vertical member 12, i.e. the dart/stake or anchor 32, is also shown (silhouetted in FIG. 1 and focused on in FIG. 3. That representative dart 32 measures about 30 inches in total length with its fins 34 extending about 16 inches or slightly more than halfway. In most applications, at least about 3 to 4 inches of fins 34 get countersunk when dart/anchor 32 is first driven into the ground. With that arrangement, there is little to no chance that vertical post 12 and signage mounted onto said anchor will lean at an odd angle (i.e. other than 90 degrees or perpendicular to the ground) or otherwise be susceptible to rocking back and forth.

It is understood that fins 34 to dart/anchor 32 would rest against the four corners of a post having a generally rectangular, preferably square, interior cross-section. In other variations, dart/anchor 32 may have oval, circular, star, triangular or polygonal shapes for fitting snugly against the sides of a vertical post 12 whose innermost cavity I would be correspondingly shaped.

It is preferred that dart/anchor component be manufactured from steel or aluminum. While other materials such as sturdy plastics or composites may be substituted therefor, the driving installation of such post anchors makes metal darts preferable. These darts may be coated or painted to be more rust resistant. They can also be sprayed with lubricant before positioning at or near the ground for easier driving to the desired depth.

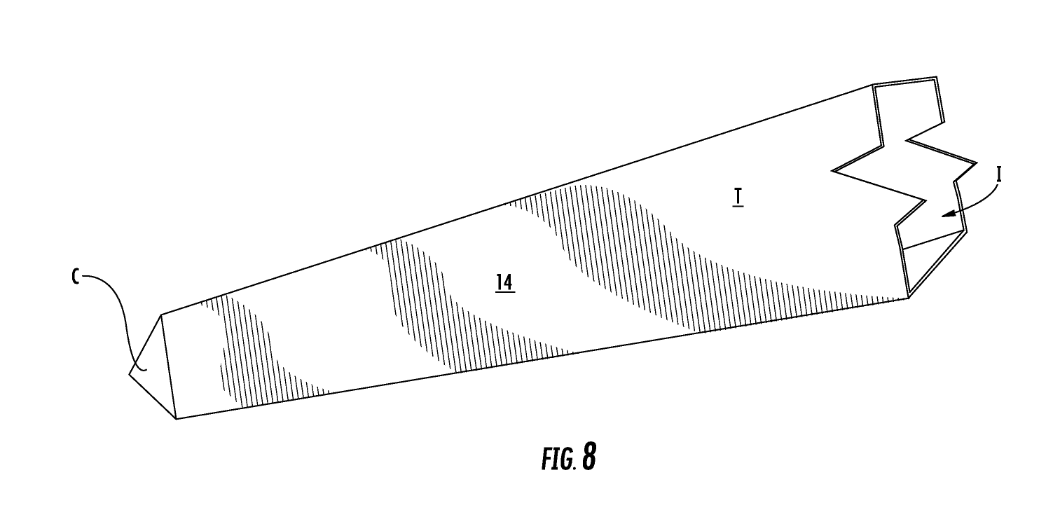

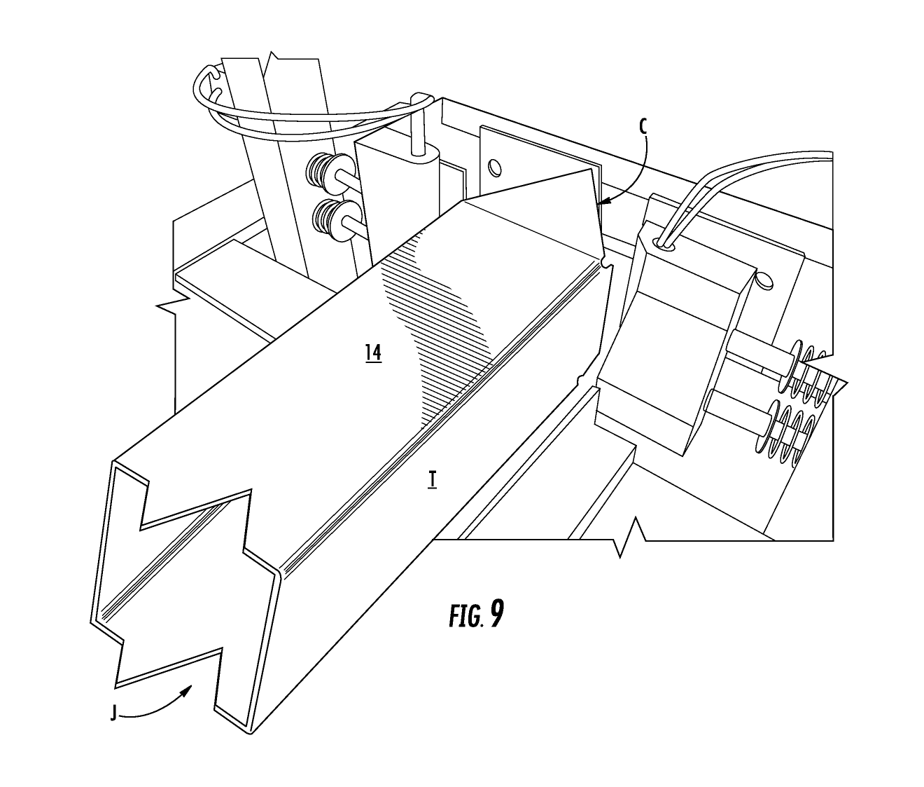

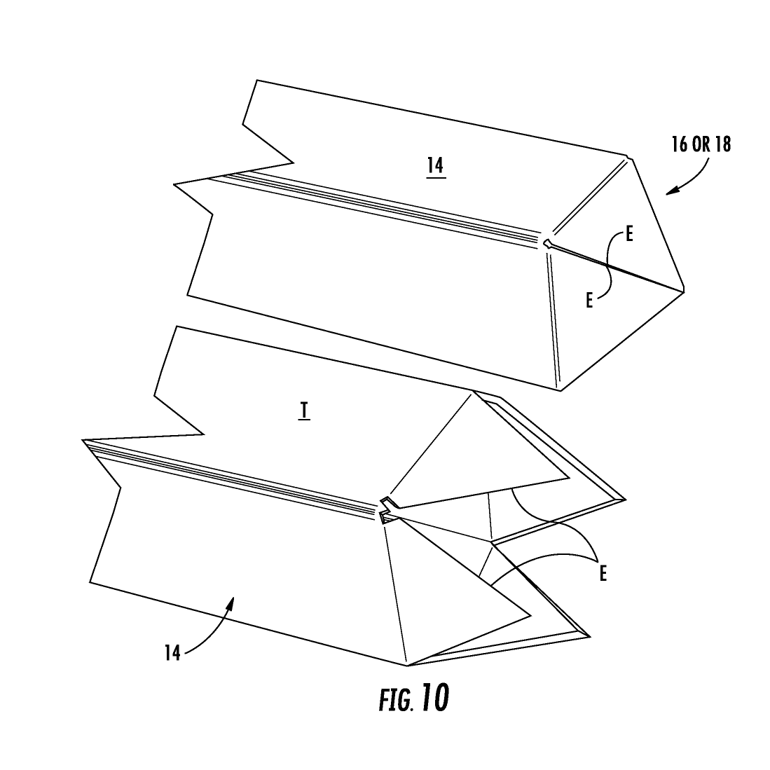

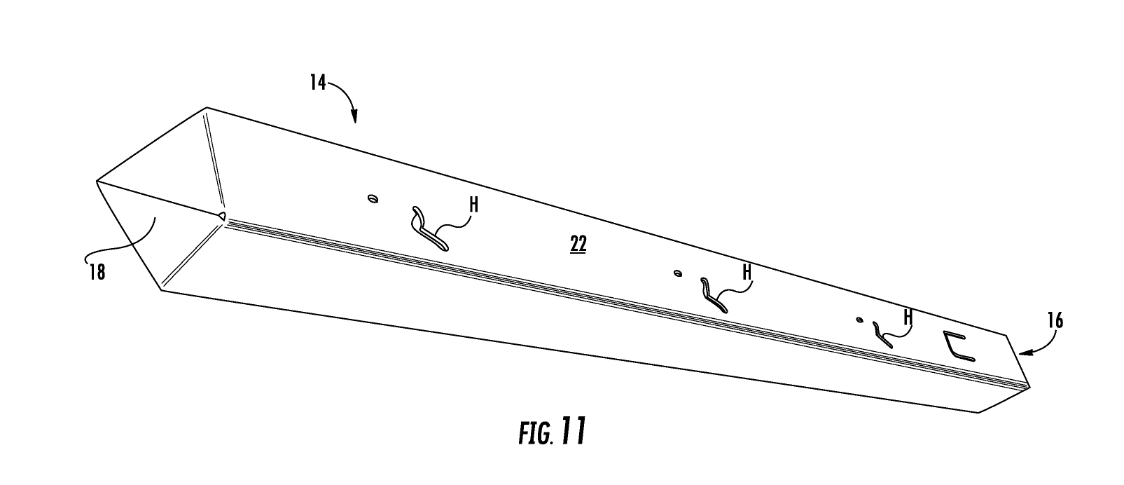

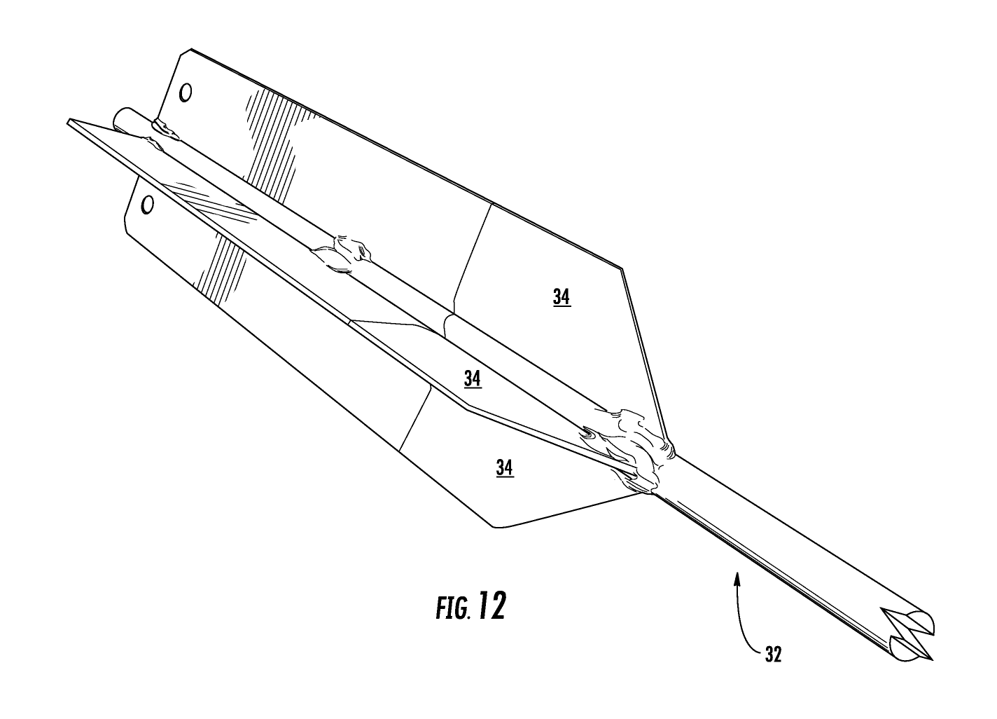

FIGS. 7 through 10 depict some of the preferred method steps for making a representative horizontal member 14 according to this invention. It is part of the whole assembly as shown in FIG. 7. FIG. 8 shows a section of vinyl tubing T having a hollow interior I, and generally square-shaped in cross-section. A first end of that tubing T is cut, preferably into 4 wedge-shaped tips angled at about 45 degrees for forming a crimped end C. In FIG. 9, that crimped end C is placed on a platen or other heating means to sufficiently warm the material so as to be folded onto itself whereupon adjacent edges E will come near one another or possibly even contact with each other to form a tip (either 16 or 18). Those steps are sequentially shown in the two views at accompanying FIG. 10. After sufficient cooling, holes H for the clip/brackets (24) are cut into the underside 22 of post 14 as best seen in accompanying FIG. 11.

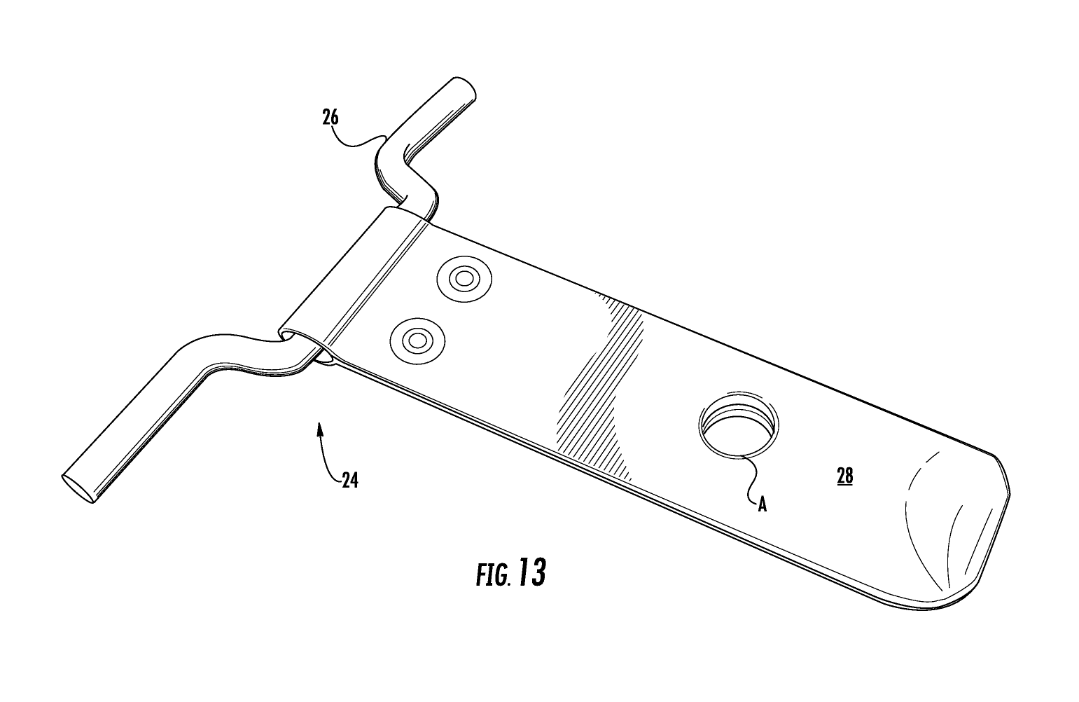

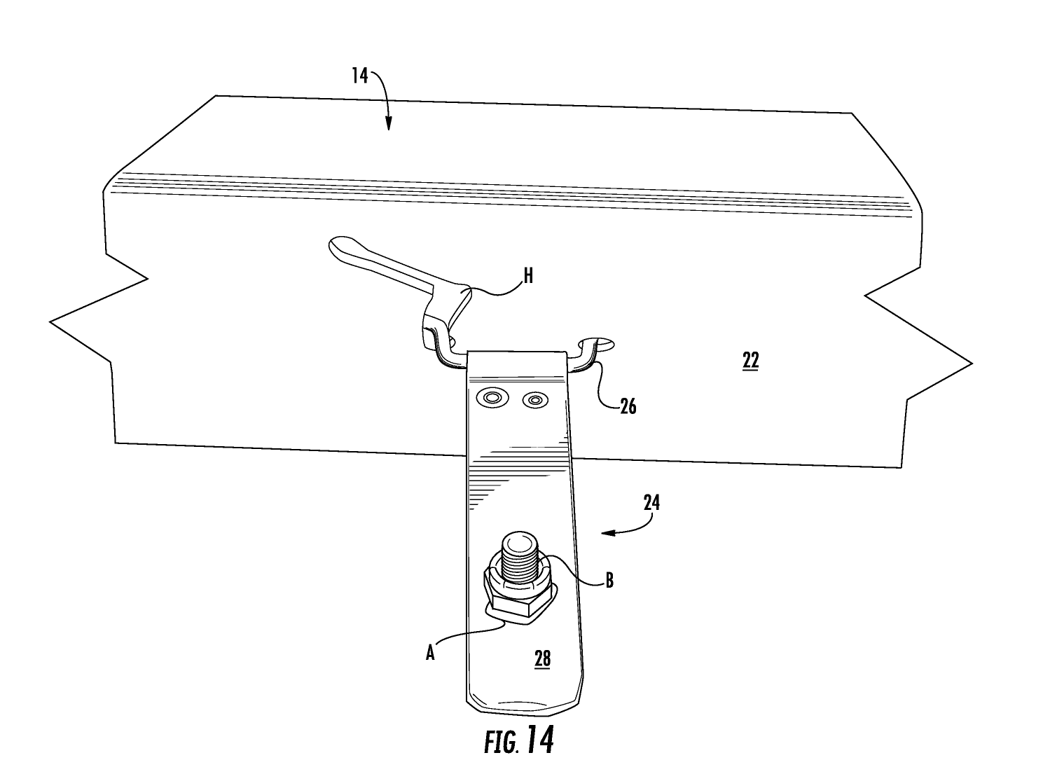

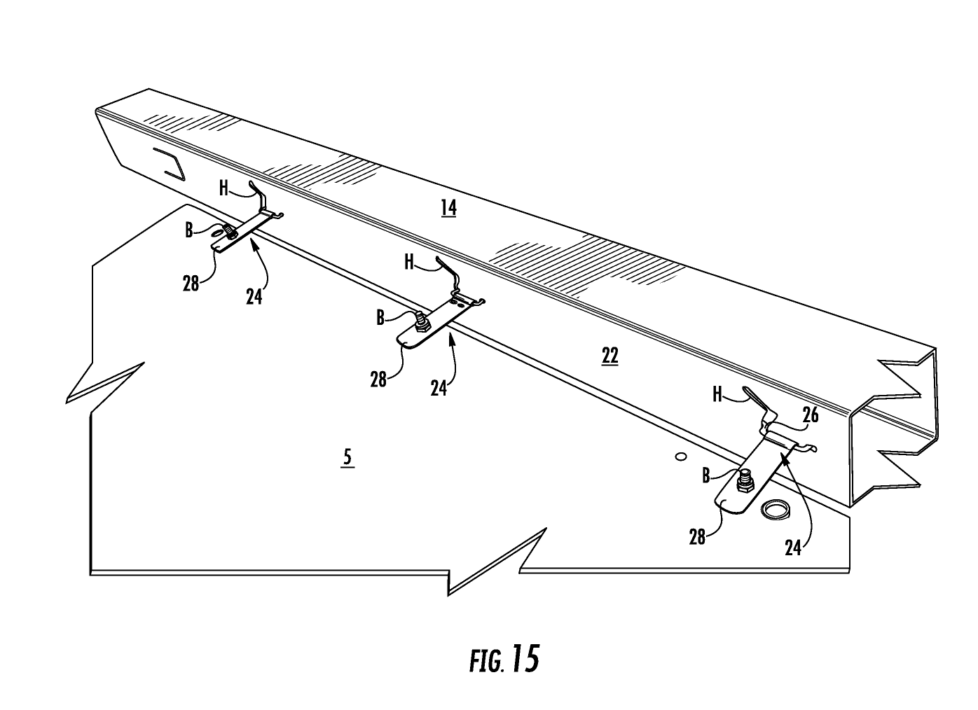

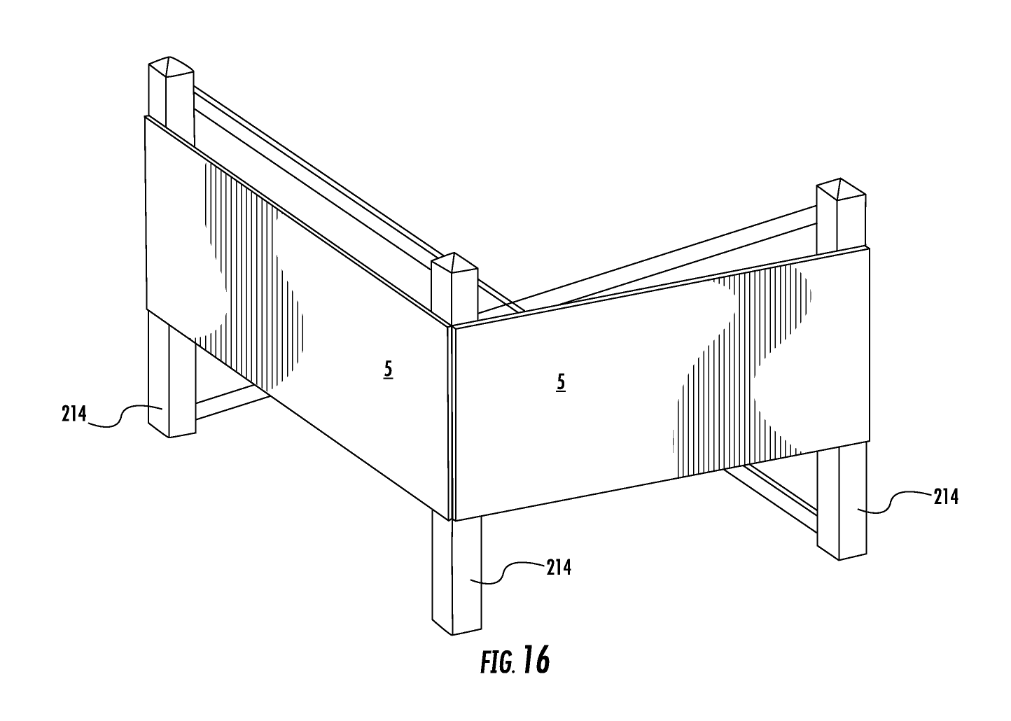

FIG. 12 is a focused view of the one preferred embodiment of dart/anchor 32 (and its plurality of fins 34 onto which vertical post 12 is ultimately positioned. FIGS. 13 through 15 focus on the clip/bracket and its mounting of a swinging realty sign 5.

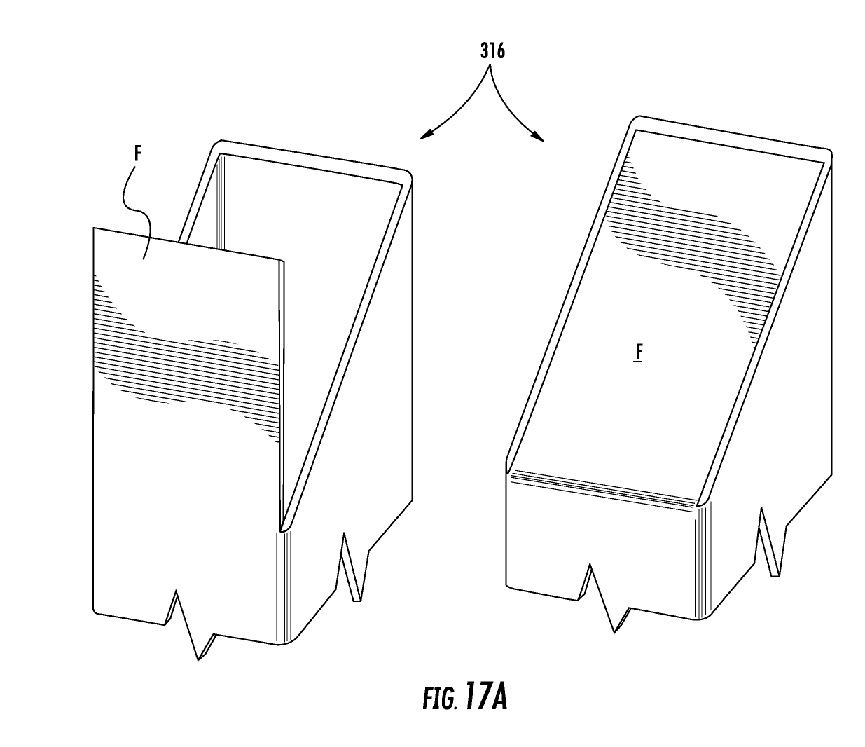

FIG. 16 shows yet another embodiment using 2 or more vertical posts 214 for hanging commercial realty sign panels (plural). As depicted, there are 3 such posts installed to form a corner display, with two panels angled at least about 90 degrees apart from each other.

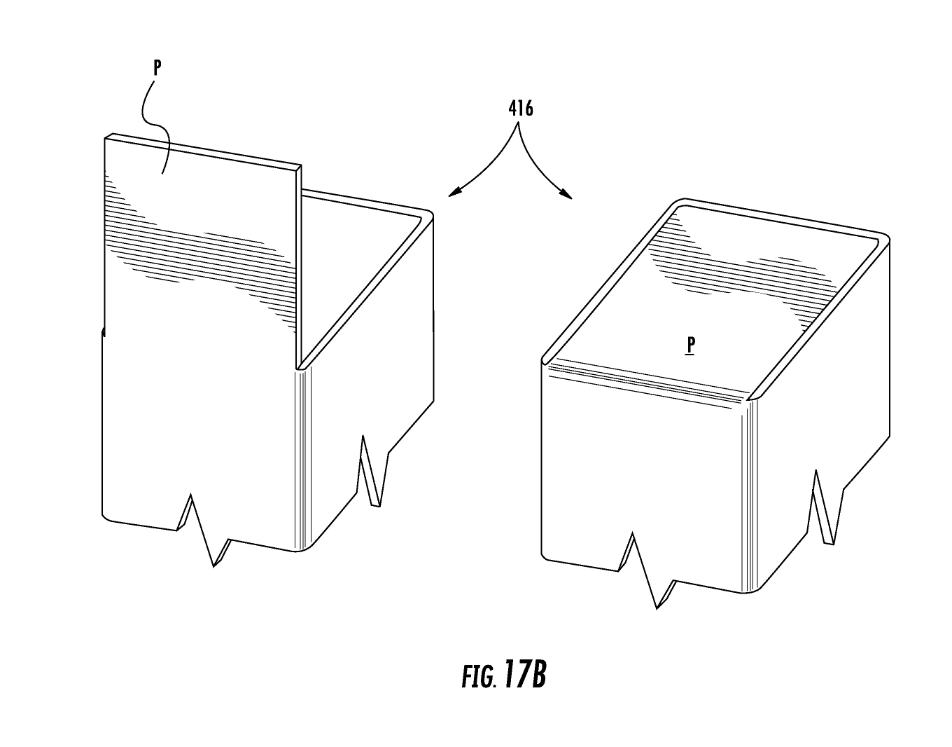

FIG. 17A shows a first alternate tip end 316 with only one, single slanted face/surface (rather than beveling inwardly from all four corners). In the left side view, that slanted angle face F has been cut and readied for attachment to the remainder of the end piece (usually with the application of at least some edging heat).

FIG. 17B shows a second alternative tip end 416, this one having no bevel/slant whatsoever. In its left view, a panel P is prepared before folding and heating onto itself resulting in a substantially flat outermost tip end that runs perpendicular to the overall length (or height) of its horizontal (or vertical) post member 414.

### EXAMPLE:

### Vinyl Sign Post Manufacture and Installation

I—UPRIGHT (4″×4″ SQUARE VINYL EXTRUSION)
   A—CHOP SAW
      1—SET RUNOFF AT 72″ AND CUT TO LENGTH
   B—COPY ROUTER
      1—CLAMP UPRIGHT WITH TOP END OF UPRIGHT LINED UP WITH “FRONT CUTOUT” MARK AND ROUT 3½″ SQUARE IN UPRIGHT USING TEMPLATE
      2—SPIN UPRIGHT OVER AND CLAMP WITH TOP END LINED UP WITH “BACK CUTOUT” MARK AND ROUT 3½″ SQUARE IN UPRIGHT USING TEMPLATE
   C—TIP CUTTING SAW
      1—CLAMP TOP END OF UPRIGHT IN SAW CRADLE WITH TOP END AGAINST STOP. LOWER SAW BLADE AND CUT THOUGH POST UNTIL SAW HITS LOWER STOP
      2—SPIN POST 90° AND REPEAT STEP 1
      3—REPEAT STEPS 2 AND 1 ON REMAINING SIDES
   D—TIP FORMING MACHINE
      1—PLACE TOP END OF UPRIGHT ON TABLE AND SLIDE TOWARD HEAT PLATENS UNTIL END HITS STOP
      2—PULL UP LEVER AND BRING HEAT PLATENS IN CONTACT WITH SIDES OF UPRIGHT
      3—HEAT SIDES OF UPRIGHT FOR ABOUT 1.5 MIN.
      4—MOVE HEATERS AWAY FROM SIDES AND BEND LEAVES INWARD AND LINE LEAVE POINTS TOGETHER—HOLD UNTIL COOL—ABOUT 30 SEC.
      5—SPIN UPRIGHT 90° AND REPEAT STEPS 1-4 FOR OTHER 2 LEAVES
II—CROSS ARM (3.½″×3.½″ SQUARE VINYL EXTRUSION)
   A—CHOP SAW
      1—SET RUNOFF TO 48″ AND CUT TO LENGTH
   B—COPY ROUTER
      1—LAY STORY POLE ON X-ARM AND MARK THE CENTER LINES FOR THE HANGER CLIO CUTOUTS AND THE LOCATOR CUTOUT
      2—CLAMP X-ARM IN ROUTER LINING UP ONE OF THE HANGER CLIP CUTOUT CENTERLINES WITH THE CENTERLINE ON TABLE AND ROUT OUT THE X-ARM USING HANGER CLIP CUTOUT TEMPLATE
      3—REPEAT STEP 2 FOR REMAINING TWO HANGER CLIP CENTERLINES
      4—REPEAT STEP 2 FOR LOCATOR CUTOUT CENTER-LINE USING LOCATOR CUOUT TEMPLATE
   C—TIP CUTTING SAW
      1—PERFORM STEPS 1-3 DETAILED IN I UPRIGHT
         C—TIP CUTTING SAW ON BOTH ENDS OF X-ARM
   D—TIP FORMING MACHINE
      1—PERFORM STEPS 1-5 DETAILED IN I UPRIGHT
         D—TIP FORMING MACHINE ON BOTH ENDS OF X-ARM
III—HANGER CLIPS ( 3/16″ UTILITY WIRE AND ¾″×0.030″ S.S. STRAP)
   A—METAL SHEAR
      1—PLACE STAPPING IN GAUGE AND SHEAR TO LENGTH (6″)
   B—PRESS WITH HANGER TOOLING INSTALLED
      1—PLACE WIRE IN TOOLING AND PRESS FORM HANGER
      2—CUT TO LENGTH WITH WIRE CUTTERS
   C—ARBOR PRESS WITH ASSEMBLY TOOLING INSTALLED
      1—BEND STRAP IN HALF AROUND CENTER OF HANGER
      2—PLACE UNIT IN ASSEMBLY TOOLING AND PRESS STRAP AROUND HANGER
      3—TURN HANGER CLIP OVER AND REPEAT STEP 2
   D—SPOT WELDER
      1—PLACE HANGER CLIP IN SPOT WELDER TONGS ⅛″ FROM EDGE OF STRAP AND NEAR CRIMP AT HANGER WIRE AND SPOT WELD
      2—REPEAT STEP 1 ⅛′ FROM EDGE ON OTHER EDGE OF STRAP
   E—DRILL PRESS
      1—PLACE HANGER CLIP IN VICE SET-UP AND DRILL 5/16″ HOLE THROUGH CENTER OF STRAPPING

While certain illustrative embodiments have been shown in the photographs and described above in considerable detail, it should be understood that there is no intention to limit the invention to the specific forms disclosed.

What is claimed is:

1. A vinyl yard post comprising a straight section of hollow rectangular extrudate adapted for positioning, at one end, over a post anchor that is sized and shaped to fit inside that one end of the hollow rectangular extrudate, an opposite end of the hollow rectangular extrudate being adapted for heating, folding and joining to itself.

2. The vinyl yard post of claim 1, which is part of a modular mailbox post having an aperture sized to support and fixedly connect with a horizontal component made from its own straight section of hollow rectangular extrudate.

3. The vinyl yard post of claim 1, which is suitable for use as a fence post.

4. The vinyl yard post of claim 1, which when combined with one or more other similar vinyl yard posts can serve to hold one or more commercial realty signs.

5. The vinyl yard post of claim 1, which is part of a modular realty signpost, said yard post serving as a substantially vertically extending component that has an aperture sized to support and fixedly connect with a horizontal component made from its own straight section of hollow rectangular extrudate.

6. The vinyl realty signpost of claim 5 wherein said vertically extending component and said horizontal component each have a square-shaped exterior cross-section.

7. The vinyl realty signpost of claim 5, which has a interior cross-section shaped to correspond with and receive an upper section of post anchor having a plurality of outwardly extending fins.

8. The vinyl realty signpost of claim 5, which has a interior cross-section shaped to correspond with and receive an upper section of post anchor, said upper post anchor section having a shape selected from the group consisting of: a triangle, a star, a circle, an oval and a polygon.

9. A modular realty signpost comprising:
a first vertical sign section made from extruded vinyl tubing;
a second horizontal sign section made from extruded vinyl tubing and designed to intersect and connect with the first vertical sign section; and
a plurality of clip and bracket combinations for holding a swinging realty sign, each of said clips designed to fit in an aperture in a bottom surface of the second horizontal sign section.

10. The modular signpost of claim 9, which includes three or more clip and bracket combinations.

11. The modular signpost of claim 9 wherein one end of the first vertical sign section and one end of the second horizontal sign section each terminate in a cut and folded taper tip.

12. The modular signpost of claim 11 wherein said cut and folded taper tips are heated for joinder along adjacent edges.

13. The modular signpost of claim 9 wherein the first vertical sign section has a hollow interior having a shaped cross-section for resting on or against a yard stake with an upper tip extension complementary in shape to the hollow interior of the first vertical sign section.

14. The modular signpost of claim 13 wherein the cross-section of the hollow interior of the first vertical sign section is substantially square shaped and the upper tip extension of the yard stake includes a plurality of fins for fitting into one or more corners of the square shaped hollow interior.

15. The modular signpost of claim 9, which further includes at least one of: a flyer box, a recorder/play back device and an audio transmitter.

16. A method for making a realty signpost with vertical and horizontal vinyl tubing components, said method comprising:
making one or more angled cuts into one end of the vinyl tubing for each sign post component;
heating the cut end; and
folding the cut end to form a tapered end that does not require capping.

17. The method of claim 16 wherein each vinyl tubing component has a rectangular cross-section exterior.

18. The method of claim 17 wherein each vinyl tubing component has a square-shaped cross-section exterior.

19. The method of claim 18 wherein each end is provided with four angled cuts, 45 degrees from a center to each vinyl tubing component sidewall.

20. The method of claim 19 wherein the tapered end has a pointed tip.
